(19) United States
(12) Patent Application Publication
(10) Pub. No.: US 2007/0222545 A1
(43) Pub. Date: Sep. 27, 2007

(54) APPARATUS FOR SHIMMING A MAGNETIC FIELD

(76) Inventors: Stuart Paul Feltham, Bicester (GB); Matthew Hobbs, Oxford (GB); Marcel Jan Marie Kruip, Oxford (GB)

Correspondence Address: SCHIFF HARDIN, LLP;PATENT DEPARTMENT, 6600 SEARS TOWER, CHICAGO, IL, 60606-6473, US

(21) Appl. No.: 11/688,973

(22) Filed: Mar. 21, 2007

(30) Foreign Application Priority Data
Mar. 21, 2006 (GB) 0605637.8

(51) Int. Cl. H01F 7/00

(52) U.S. Cl. 335/301

(57) ABSTRACT

An apparatus for shimming the magnetic field generated by a magnet arrangement of a magnetic resonance imaging (MRI) system has a number of discrete shim units; at least some of the discrete shim units exhibiting differing ferromagnetic characteristics, a channel incorporated in the magnet arrangement and disposed to receive a predetermined distribution of the discrete shim units to provide a required distribution of the ferromagnetic characteristics in relation to the magnetic field; a presenting arrangement for automatically presenting the discrete shim units at an entrance to the channel, in a sequence conforming to the distribution, and a powered arrangement for inserting the discrete shim units into the receiving channel in the sequence as presented.

### BACKGROUND OF THE INVENTION

1. Field of the Invention

This invention relates to apparatus for and methods of improving the homogeneity of magnetic fields generated by the magnet arrangements utilized in magnetic resonance imaging (MRI) systems.

2. Description of the Prior Art

It is well known that, in order to achieve, over the field of view (FOV) of an MRI system, the high degree of field homogeneity (typically less than 5 ppm) required of the powerful magnetic fields employed, corrective measures need to be taken, since the fields as generated by the magnets tend to be inhomogeneous to an unacceptable extent (typically 500 ppm).

A common and effective corrective measure involves the measurement of the field characteristics to reveal its degree of spatial homogeneity, the calculation of field distortion necessary to correct inhomogeneities to a prescribed extent, and the provision of a distributed array of individual pieces of ferromagnetic material, such as sheet steel or iron, with differing ferromagnetic characteristics, at a convenient position in relation to the magnet structure and the FOV of the MRI system to provide the required field distortion. These pieces of ferromagnetic material are known as “shims”, and their differing ferromagnetic characteristics may, for example, result from the use of shims of varying thicknesses. In any event, shims having appropriate ferromagnetic characteristics to achieve the desired spatial field distortion are selected and placed so as to distort the generated magnetic field in a sense such as to improve the homogeneity of the magnetic field across the FOV; the corrective process as a whole being referred to as “shimming”.

Typically in practice, shims selected as described above, and in accordance with the desired corrective procedure, are placed within respective pockets in a tray, called a “shim tray”, which is slid into a receiving slot until located as desired, and several trays are typically deployed, in respective receiving slots, so as to surround the FOV. Such an arrangement is disclosed, for example, in WO 2005/114242 A2, the disclosure of which is incorporated herein by reference.

### SUMMARY OF THE INVENTION

A general difficulty encountered with the shimming process is that of ensuring that shims having the correct ferromagnetic characteristics are loaded into the correct pocket locations in the shim trays, and the object of the invention is to reduce or eliminate this difficulty.

The loading of shims into the shim trays is conventionally carried out manually. The loading process is a long and tedious task, and frequently errors are made which are difficult to detect, and which prolong the overall shimming process by requiring additional iterations of the measurement and calculation stages.

The invention allows the loading process to be reliably automated, thereby reducing the difficulties described above.

According to the invention an apparatus for shimming the magnetic field generated by a magnet arrangement of a magnetic resonance imaging (MRI) system has a number of discrete shim units; at least some of the discrete shim units exhibiting differing ferromagnetic characteristics, a channel incorporated in the magnet arrangement and disposed to receive a predetermined distribution of the discrete shim units to provide a required distribution of the ferromagnetic characteristics in relation to the magnetic field; a presenting unit for automatically presenting the discrete shim units at an entrance to the channel, in a sequence conforming to the distribution, and a powered arrangement for inserting the discrete shim units into the receiving channel in the sequence as presented.

Preferably, the powered arrangement for inserting the discrete shim units into the receiving channel is a force unit adapted to direct fluid under pressure on the discrete shim units as presented and to urge them in turn toward the entrance into the channel.

It is particularly preferred that, where more than one receiving channel is provided in a given MRI magnet system, each channel entrance bears coding that is recognizable by a detector associated with the force unit to ensure that the correct distribution of discrete shim units is inserted into each channel. Such coding may be or include, for example, a pinning pattern or an optical pattern.

Also preferably, a filled channel entrance is coded to indicate that no further discrete shim units should be inserted therein By this feature, the force unit can be disabled if it is wrongly positioned to insert discrete shim units into a channel that has already been filled with its proper distribution of discrete shim units.

The magnetic resonance imaging (MRI) system may be an open-magnet magnetic resonance imaging (MRI) system.

The tubular receiving channel may be configured and dimensioned to receive discrete shim units of any predetermined shape, such as spherical, cylindrical, rectangular, triangular or hexagonal, for example.

Preferably, and as described in co-pending UK patent application No. GB0605640.2, the discrete shim units each have a ferromagnetic core of selected dimensions, each individually encapsulated in a non-magnetic shell. The material of the shell is preferably electrically insulating, to reduce the changes of disturbance of the magnetic field due to eddy currents flowing in the discrete shim units. The shells preferably are all of the same shape and size, to facilitate automated handling and positioning. In this way, the discrete shim units, once serially loaded into the receiving channel, can be held reliably in position therein by contact between adjacent shells. End shim units or dummy shim units of slightly larger dimensions may be used, if desired, to firmly close the end of a receiving channel. Alternatively, suitably shaped closures, preferably incorporating resilient pads (or other suitable resilient means) to apply end-pressure to the assembled discrete shim units, can be utilized.

The receiving channels may be provided as separate entities into which the discrete shim units can be loaded before or after installation into the MRI magnet system. Alternatively, and preferably, the channels may comprise passageways molded or otherwise created within the magnet system or encapsulants therefor, and the discrete shim units loaded into them.

Whether the receiving channels are separate entities or formed in the magnet system or encapsulants therefor, they may be straight or they may meander in one or more planes to provide an extended enclosure.

### DESCRIPTION OF THE DRAWINGS

FIGS. 1A-1D show a typical gradient coil layout and illustrate the location of a receiving channel therein for discrete shim units of the invention, for an open-magnet magnetic resonance imaging (MRI) system.

FIG. 2 shows, in simplified and block diagrammatic view, certain elements of an automated system for selecting discrete shim units, feeding them in a predetermined sequence to an insertion point, where they are presented serially for insertion into a channel and for inserting them into the appropriate channel.

FIG. 3 shows, in partially cut-away view, one example of a discrete shim unit for use in apparatus according to one embodiment of the invention.

FIG. 4 shows another example of a discrete shim unit for use in apparatus according to an embodiment of the invention.

FIG. 5 shows a further example of a discrete shim unit for use in apparatus according to another embodiment of the invention.

### DESCRIPTION OF THE PREFERRED EMBODIMENTS

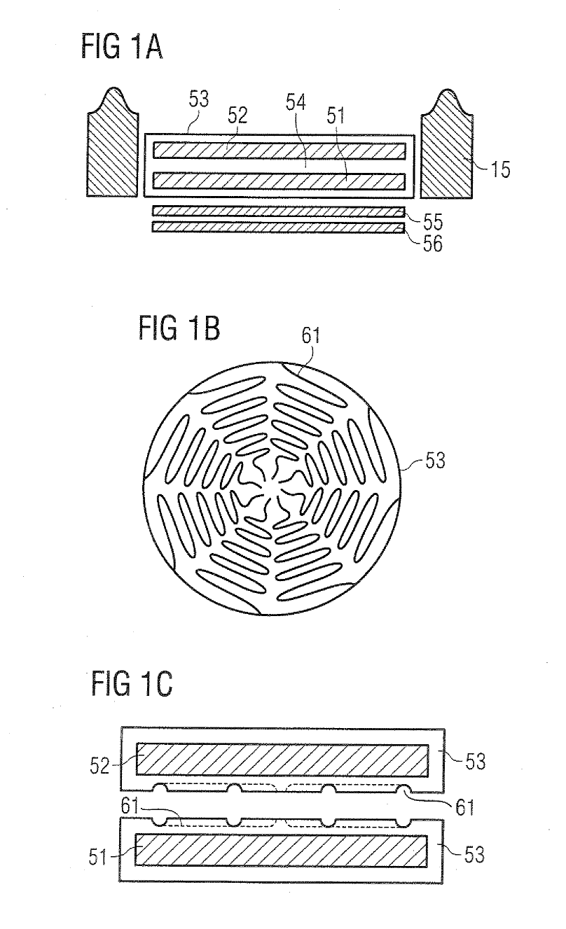

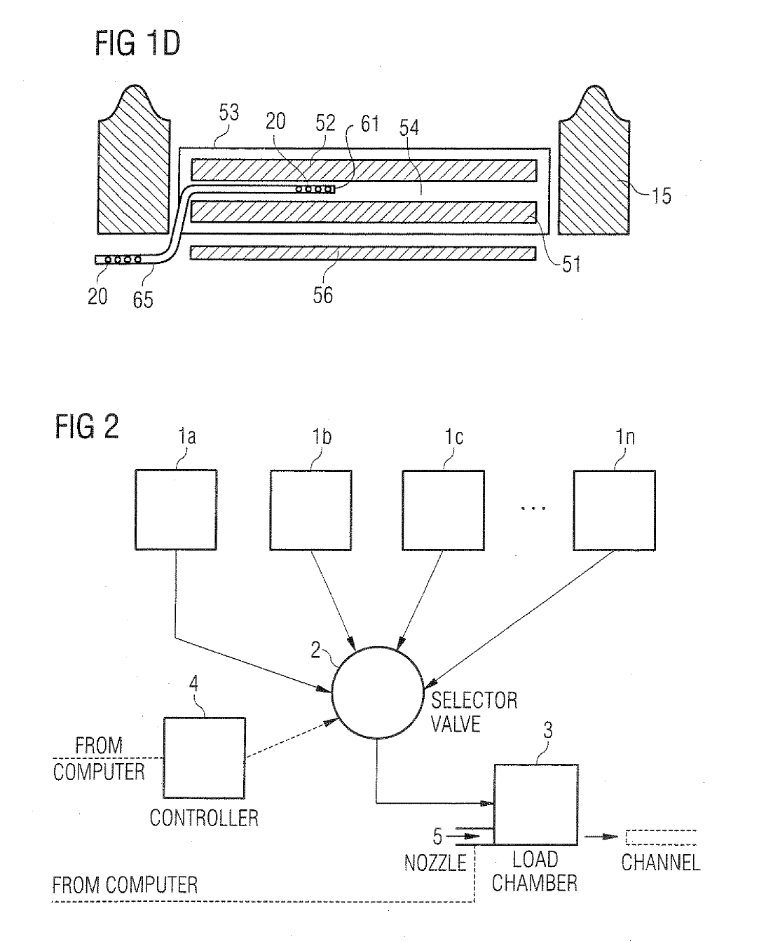

The invention will be described hereinafter in the context of an open-magnet magnetic resonance imaging (MRI) system, and it will be understood that the gradient coil assemblies in such systems are usually planar in shape. A cross section through a typical planar gradient coil set is shown in FIG. 1A.

The gradient coils consist of a so called primary coil set 51, which comprises: one X-direction gradient coil set, one Y-direction gradient coil set and one Z-direction gradient coil set. The stray fields of this primary gradient coil set will interact with the conducting surfaces in the pole face or the cryostat. To limit these fields, a so called secondary gradient coil set 52 may be included for some or all of the X-, Y-, or Z-directions, which includes at least a secondary coil set for the gradient coil with the most perturbing primary gradient coil, Preferably, to limit relative movement and to facilitate assembly, the primary and secondary gradient coil sets 51, 52 impregnated and encapsulated within a resin encapsulant 53.

Some space 54 is required between the primary and secondary gradient coils to make the shielded gradient coils work at acceptable power levels because, unless sufficient space is provided, the coils start to compete with each other for power, at the expense of a high dissipation. This space is typically filled with a region of solid encapsulant during the coil impregnation process.

In a preferred embodiment of the present invention, provision is made for a receiving passage for the insertion of shimming devices in the space 54 between the primary and the secondary gradient coils. It is preferred that the receiving passages for the discrete shim units are formed within the structure of the magnet assembly. The receiving channels have a cross-sectional diameter which is slightly larger than the diameter of discrete shim units to be inserted therein, described below.

In an example embodiment, illustrated in FIGS. 1B and 1C, receiving channels 61 for discrete shim units may be formed within the encapsulant 53 filling the space 54. As shown in FIG. 1B, such receiving channels 61 may be arranged in serpentine form, repeated in segments around the area of the gradient coils. Many alternative configurations of receiving channels are of course possible, such as spiral configurations, straight radial configurations or arrangements of straight or curved, parallel receiving channels.

As shown in FIG. 1C, the receiving channels may conveniently be formed by encapsulating the primary and secondary gradient coils separately, in suitably shaped moulds. The separate encapsulated coils may then be bonded together to define the receiving channels. Alternatively, suitably shaped pieces of a sacrificial material such as paraffin wax may be included within the space 54 when the coils are impregnated and encapsulated. When encapsulation is complete, the resultant structure is heated above the melting point of the material, which escapes to leave receiving channels of the desired configuration.

For receiving channels of an appropriate configuration, it may be possible to create them within a solid block of encapsulant by machining processes.

FIG. 1D illustrates a possible arrangement of a receiving channel 61 between primary and secondary gradient coils. The advantage of such an arrangement is that the discrete shim units provided by the present invention may be arranged in a plane between the two gradient coils, within the Rose ring, without needing to mechanically remove any pieces of equipment The discrete shim units are simply driven, as required, into the channels to come to rest at the respective required position. A discrete shim unit providing means is schematically illustrated at 65, in the process of introducing discrete shim units 20 into receiving channel 61.

In some circumstances, however, for example where it is not possible to create a channel with sufficient precision, the discrete shim units may be pre-loaded into an elongate, tubular envelope of non-ferromagnetic material, and the entire assembly pushed into place in the magnet system.

In one embodiment of the invention, as shown in FIG. 2, discrete shim units having a range of ferromagnetic characteristics are pre-classified as to their characteristics and stored in respective magazines 1a, 1b, 1c to 1n; each magazine storing discrete shim units with similar ferromagnetic characteristics.

Respective outputs through which the stored discrete shim units can be withdrawn from the various magazines 1a through 1n are coupled to a common selector valve 2 which selectively couples any given output to a load chamber 3 which is positioned adjacent an entrance to a receiving channel and presents discrete shim units, supplied thereto by way of the selector valve 2, in an appropriate attitude for insertion into the channel. The operation of the selector valve 2 is controlled by a controller 4 which operates under the control of a computer (not shown) programmed with a predetermined sequence of discrete shim units that has been calculated as required for application to the channel in question. Thus, discrete shim units are presented serially at the load chamber 3 for insertion into the channel in accordance with the appropriate, predetermined sequence.

Associated with the load chamber 3 is a nozzle 5 which delivers, under computer control, bursts of a propellant fluid such as compressed air, which are effective to cause insertion into the channel of discrete shim units presented serially at the load chamber 3. Clearly, in some circumstances, that end of the channel remote from its entrance may require a fluid outlet connection to provide an operating circuit for the fluid.

In operation, therefore, discrete shim units are selected in sequence from the magazines 1 under computer control and in dependence upon a required distribution of ferromagnetic characteristics along a given channel, and the selected discrete shim units are presented serially at the load chamber, from which point they are forced, under computer control, into the channel entrance. As subsequent discrete shim units are forced into the channel, each pushes the previously inserted discrete shim units along until the first-inserted discrete shim units encounters the far end of the channel, at which point the channel has been filled.

It is desirable that a filled channel be protected from the attempted insertion of any further discrete shim units, and this can be achieved in various ways. For example, the controller 4 may be caused to emit a warning signal when the loading of a channel is complete, thus alerting an operator who removes the loading chamber 3 and the associated nozzle and places a blanking piece over the entrance of the filled channel. Preferably the blanking piece carries a code which can be recognized by a sensor associated with the loading chamber 3 and/or the nozzle 5, and disables the selector valve 2 and the nozzle 5 if an attempt is made to further load an already-loaded channel.

It will be appreciated that any given predetermined sequence of discrete shim units is calculated uniquely for a given channel, thus it is highly preferable that means are provided to ensure the insertion of each sequence of discrete shim units into the particular channel for which it was calculated to be appropriate. In one embodiment of the invention, the entrance to each channel is configured to carry a unique code, for example a pinning code or a visual code, and a sensor device is provided on the loading chamber and/or the nozzle 5 to detect the code. This detected code is then applied to the computer for correlation with the unique code for the channel designated to receive the sequence of discrete shim units under selection. Only if the allocated and sensed codings correspond are the mechanisms for selecting, transporting, presenting and inserting a sequence of discrete shim units permitted to operate.

The foregoing fail-safe system can also be utilized to prevent the further filling of an already-full channel by arranging that the code associated with a filled channel is automatically changed, removed or obscured such that no correlation between sensed and actual codes exists for a filled channel.

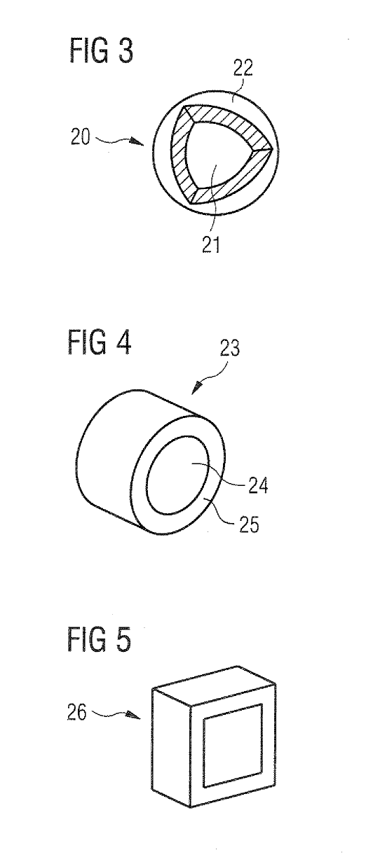

In a preferred embodiment of the invention, discrete shim units, such as those described and claimed in the aforementioned co-pending patent application of even date herewith, are inserted into the receiving channels. Such discrete shim units comprise, for example, ball-like devices 20 in the form of spheres, each containing one or more ferromagnetic artifact(s) such as a ball bearing 21 coated with a non-magnetic material 22 as shown in FIG. 3, which shows a discrete shim unit in the form of a ball with the material 22 shown partially removed for illustrative purposes. Material 22 is preferably electrically insulating, to reduce the chances of disturbance of the magnetic field due to eddy currents flowing in the discrete shim units. The shims such as 20 are inserted in one or more elongate, tubular, receiving channels (not shown), preferably situated (as described above) between the primary and secondary coil sets.

The receiving channels have a cross-sectional diameter which is slightly larger than the diameter of the discrete shim units such as 20. The entrance of the receiving channel preferably has a diameter equal to or larger than the general cross-sectional diameter of the receiving channel, to assist with insertion of the discrete shim units into the receiving channel. The other end of the receiving channel can be ‘blind’ (i.e. totally closed) or it can be provided with an opening to ambient atmosphere; the opening of course having a diameter less than that of the discrete shim units such as 20.

One or more receiving channel can have one or more bends, allowing discrete shim units to be distributed in one or more planes, as desired depending upon the overall configuration of the MRI magnet system. Moreover, any given shim volume can incorporate one or more receiving 5 channels

The discrete shim units such as 20 can exhibit a range of different ferromagnetic characteristics (e.g. strength), depending inter alia on the diameter and/or material of the inner ferromagnetic artifact 21. The diameter of the ferromagnetic artifact can be zero, in which case the discrete shim unit is purely non-magnetic, providing no shimming effect in itself but useful for ensuring that the remaining discrete shim units are held in the desired location within the receiving channel.

In another embodiment, discrete shim units such as that shown in FIG. 4 at 23 can consist of or include a cylindrical ferromagnetic core 24, surrounded by cylindrical non-magnetic material 25, The material 25 is preferably electrically insulating, to reduce the chances of disturbance of the magnetic field due to eddy currents flowing in the discrete shim units. If the cross section of the receiving channel is circular, with an inner diameter slightly bigger than the outside diameter of the cylindrical discrete shim unit 23, such a discrete shim unit can only inserted in a relatively straight channel, without significant bends.

The receiving channel can be given a rectangular cross section, in which case a 90 degree bend is possible. The discrete shim units could be presented axially, one circular end first, into a receiving channel of circular cross-section. Alternatively, the shims could be presented radially, to roll along a receiving channel of rectangular cross section.

The discrete shim units can alternatively, or in addition, have a prismatic shape as shown at 26 in FIG. 5.

It will be appreciated that the shape of the ferromagnetic artifact within each discrete shim unit need not correspond to the shape of the overall discrete shim unit. Thus a ball-like ferromagnetic artifact may be encapsulated within a cylindrical shell, for example, or vice-versa. Moreover, in discrete shim units exhibiting a range of ferroelectric characteristics, there may be at least one device which comprises only a ferromagnetic artifact, i.e. with no encapsulant shell. Discrete shim units may contain many ferromagnetic artifacts rather than one or two large ones. For example, discrete shim units may comprise a mixture of a non-magnetic material, such as a plastic with numerous ferromagnetic particles embedded therein, the ratio of ferromagnetic material to non-magnetic material defining the ferromagnetic property of each discrete shim unit. The non-magnetic material is preferably electrically insulating, to reduce the chances of disturbance of the magnetic field due to eddy currents flowing in the discrete shim units.

Although modifications and changes may be suggested by those skilled in the art, it is the intention of the inventors to embody within the patent warranted hereon all changes and modifications as reasonably and properly come within the scope of their contribution to the art.

We claim as our invention:

1. An apparatus for shimming a magnetic field generated by a magnet arrangement, said apparatus comprising:
a plurality of shim devices, at least some of said shim devices exhibiting different ferromagnetic characteristics from others of said shim devices;
a structural body having at least one elongate, tubular channel therein having a cross-section dimensioned to serially receive said shim devices in a predetermined sequence to produce a predetermined distribution of said ferromagnetic characteristics with respect to said magnetic field, said channel having an entrance into which said shim devices are insertable and a length sufficient to accommodate said shim devices serially in said predetermined sequence;
a presentation unit that automatically presents said shim devices serially, in said predetermined sequence, at said entrance of said channel; and
a powered insertion arrangement that automatically inserts said shim devices serially, in said predetermined sequence presented by said presentation unit, into said channel.

2. An apparatus as claimed in claim 1 wherein said powered insertion arrangement comprises a pressurized fluid emitter that emits and directs pressurized fluid onto successive shim units presented at said entrance in said predetermined sequence by said presentation unit, to force the shim units in succession into said entrance.

3. An apparatus as claimed in claim 1 comprising a plurality of elongate, tubular channels in said structural body each having an entrance into said structural body, and comprising, at each entrance, a coding affixed to said structural body that identifies a predetermined sequence for the shim devices to be inserted into that channel, and wherein said powered insertion arrangement comprises a reader that recognizes and decodes said coding.

4. An apparatus as claimed in claim 3 wherein said coding is selected from the group consisting of a pinning pattern and an optical pattern.

5. An apparatus as claimed in claim 3 comprising a disabling unit, connected to said reader that disables said powered insertion arrangement to preclude said insertion arrangement from inserting a sequence of said shim elements that does not correspond to the predetermined sequence of said shim elements indicated by said coding.

6. An apparatus as claimed in claim 1 comprising a mechanical figuration applied to said entrance of said channel after said channel has been filled with said predetermined sequence of shim devices.

7. An apparatus as claimed in claim 5 wherein said powered insertion arrangement comprises a detector that detects said configuration, and a disabling unit connected to said detector that disables said powered insertion arrangement to preclude said powered insertion arrangement from attempting to insert further shim devices into said filled channel.

8. An apparatus as claimed in claim 1 wherein each of said shim devices comprises a ferromagnetic core of selected dimensions, encapsulated in a non-magnetic shell.

9. An apparatus as claimed in claim 8 wherein said non-magnetic material is electrically insulating.

10. An apparatus as claimed in claim 1 wherein each of said shim devices comprises a mixture of non-magnetic material with ferromagnetic particles embedded therein comprised of ferromagnetic material, with a ratio of a total amount of ferromagnetic material of said ferromagnetic particles to said non-magnetic material defining the ferromagnetic characteristic of that shim device.

11. An apparatus as claimed in claim 10 wherein said non-magnetic material is electrically insulating.

12. An apparatus as claimed in claim 1 wherein said at least one channel is a passageway in said structural body that is created in said structural body during manufacture of said structural body.

13. An apparatus as claimed in claim 1 wherein said at least one channel meanders within said structural body in at least one plane.

14. A magnetic resonance imaging system comprising:
a magnetic resonance data acquisition system comprising a magnet arrangement that generates a basic magnetic field in said data acquisition unit; and
an apparatus for shimming said magnetic field generated by said magnetic arrangement comprising a plurality of shim devices, at least some of said shim devices exhibiting different ferromagnetic characteristics from others of said shim devices, a structural body associated with said magnet system having at least one elongate, tubular channel therein having a cross-section dimensioned to serially receive said shim devices in a predetermined sequence to produce a predetermined distribution of said ferromagnetic characteristics with respect to said magnetic field, said channel having an entrance into which said shim devices are insertable and a length sufficient to accommodate said shim devices serially in said predetermined sequence, a presentation unit that automatically presents said shim devices serially, in said predetermined sequence, at said entrance of said channel, and a powered insertion arrangement that automatically inserts said shim devices serially, in said predetermined sequence presented by said presentation unit, into said channel.

15. A magnetic resonance imaging system as claimed in claim 13 wherein said magnet arrangement is an open magnet arrangement.

16. A magnetic resonance imaging system as claimed in claim 13 wherein said structural body is mechanically incorporated into said magnet arrangement.

17. A magnetic resonance imaging system as claimed in claim 13 wherein said structural body is a tubular envelope containing said tubular channel therein that is mechanically removable from and attachable to said magnet arrangement to allow insertion of said shim devices into said tubular channel in said tubular envelope by said powered insertion arrangement and said presentation unit at a location remote from said magnet arrangement.
